(19) United States
(12) Patent Application Publication
(10) Pub. No.: US 2007/0096932 A1
(43) Pub. Date: May 3, 2007

(54) Overload warning device for electric sockets

(76) Inventor: Li-Chun Lai, Panciao City (TW)

Correspondence Address: HDSL, 4331 STEVENS BATTLE LANE, FAIRFAX, VA, 22033, US

(21) Appl. No.: 11/325,540

(22) Filed: Jan. 5, 2006

(30) Foreign Application Priority Data
Nov. 2, 2005 (CN) 200520093117.5

(51) Int. Cl. G08B 21/00

(52) U.S. Cl. 340/662

(57) ABSTRACT

An overload warning device is used for electric sockets. The overload warning device of the present invention is disposed in the sockets of an extension cord or the sockets fixedly fitted in a wall. When there is an overload, the overload warning device will send out a warning sound and/or warning light so as to tell a user to unplug one or more electric plugs from the sockets so that safety may be assured.

### BACKGROUND OF THE INVENTION

1. Field of the Invention

The invention generally relates to an overload warning device for electric sockets. More particularly, the invention relates to an overload warning device that may immediately send out a warning sound and/or flashing light when there is an overload in the sockets of an extension cord or the sockets fitted in a wall so as to alert the user and ensure safety.

2. Description of the Related Art

People may conveniently insert the plug of an electric appliance into a socket of an extension cord or a socket fitted in a wall to draw AC so that such appliance may become operational. However, an overload may occur if an electric appliance draws too much current or too many appliances are used on the sockets or draw current from a single extension cord. For the protection against overloads, in the prior art, a fuse or a supplementary protector (AKA circuit breaker) is used; when there is an overload, the fuse will be burn out or the protector will be activated to interrupt the power provision so as to ensure safety.

Though such fuse and protector do provide some degree of protection against overloads, they can not provide immediate protection because a period of time is needed for the fuse to be melted or for the protector to be activated (depending on the degree of conductivity of its conducting element). Whence, there is need to have an overload warning device that may give out a warning sound or flashing light immediately upon the occurrence of an overload.

From the above, the protective devices of the prior art have many disadvantages and need to be improved.

To eliminate the disadvantages in the prior art, the inventor has put in a lot of effort in the subject and has successfully come up with the overload warning device of the present invention.

### SUMMARY OF THE INVENTION

The present invention is to provide an overload warning device that may immediately send out a warning sound and/or flashing light when there is an overload in a socket so that a user may unplug one or more electric plugs from the sockets so as to ensure safety.

Another, the present invention is to provide an overload warning device that may be used for the sockets of an extension cord, the sockets fixedly fitted in a wall or other form of sockets.

The overload warning device of the present invention comprises a socket body and a warning device. The socket body may be a socket body of an extension cord or a socket body fixedly fitted in a wall. The warning device comprises a DC supply unit, a sampling unit, an amplification unit, a comparison unit, a pulse generating unit, a driving unit and warning elements. The DC supply unit may receive AC from the socket body and convert the AC to DC by rectifing, filtering out and stabilizing the AC. The DC may then be fed to the units of the warning device. The sampling unit is connected in parallel with the neutral wire or the positive wire of the socket body so as to obtain the voltage drop signals across the sampling unit. The voltage drop signals may be amplified by the amplification unit. The comparison unit may compare the amplified voltage drop signals with a predetermined voltage value. If the former is greater than the latter, the pulse generating unit will generate a pulse signal and send it to a driving unit, which will then activate the warning elements to send out a warning sound and/or flashing light so as to alert the user and ensure safety.

These features and advantages of the present invention will be fully understood and appreciated from the following detailed description of the accompanying Drawings.

### BRIEF DESCRIPTION OF THE DRAWINGS

FIG. 1 is a block diagram schematically illustrating the overload warning device of the present invention.

FIG. 2 is a circuit diagram of a first embodiment of the present invention.

FIG. 3 is a circuit diagram of a second embodiment of the present invention.

### DETAILED DESCRIPTION OF THE PREFERRED EMBODIMENT

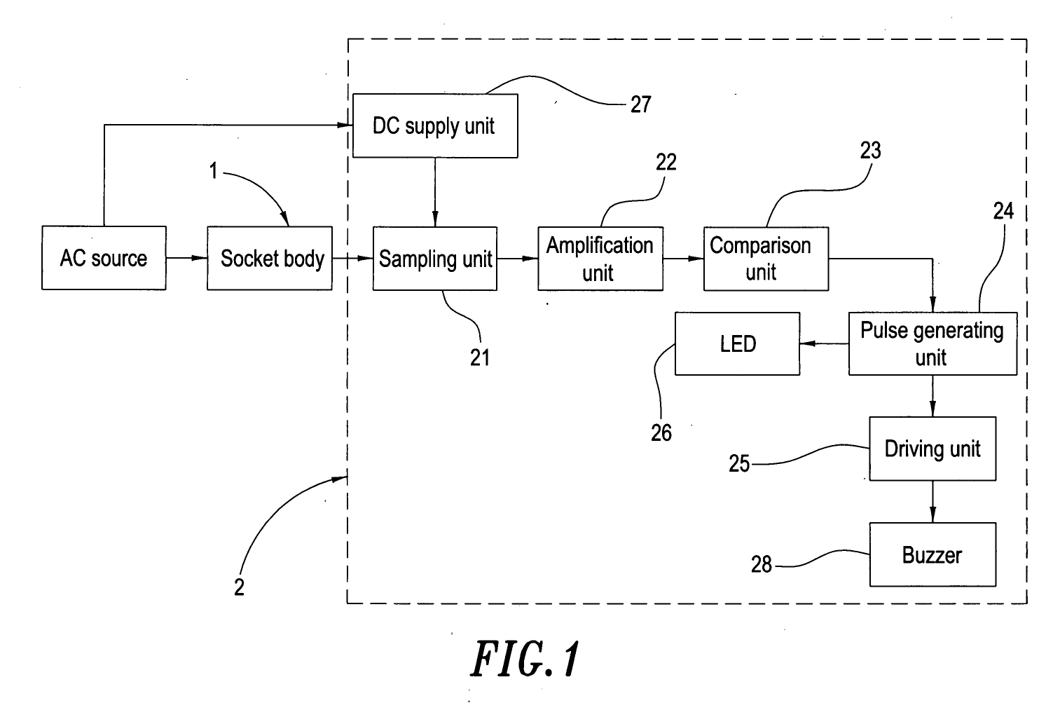

Please refer to FIG. 1 to 3. The overload warning device of the present invention comprises a socket body 1 and a warning device 2. The warning device 2 comprises a sampling unit 21, an amplification unit 22, a comparison unit 23, a pulse generating unit 24 and a DC supply unit 27.

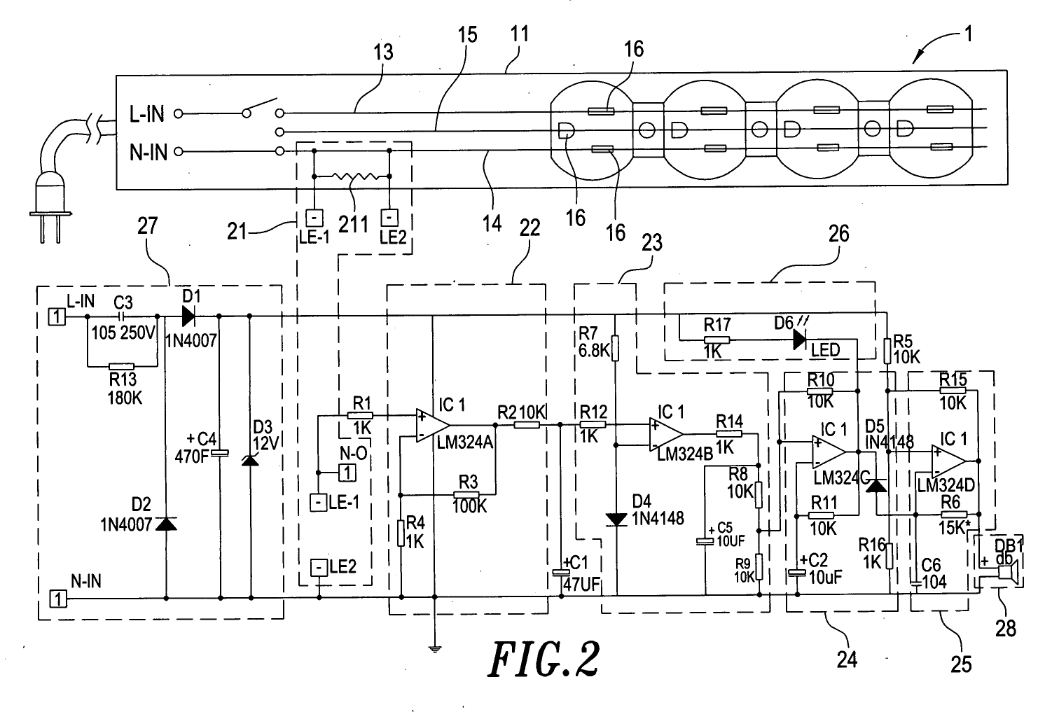

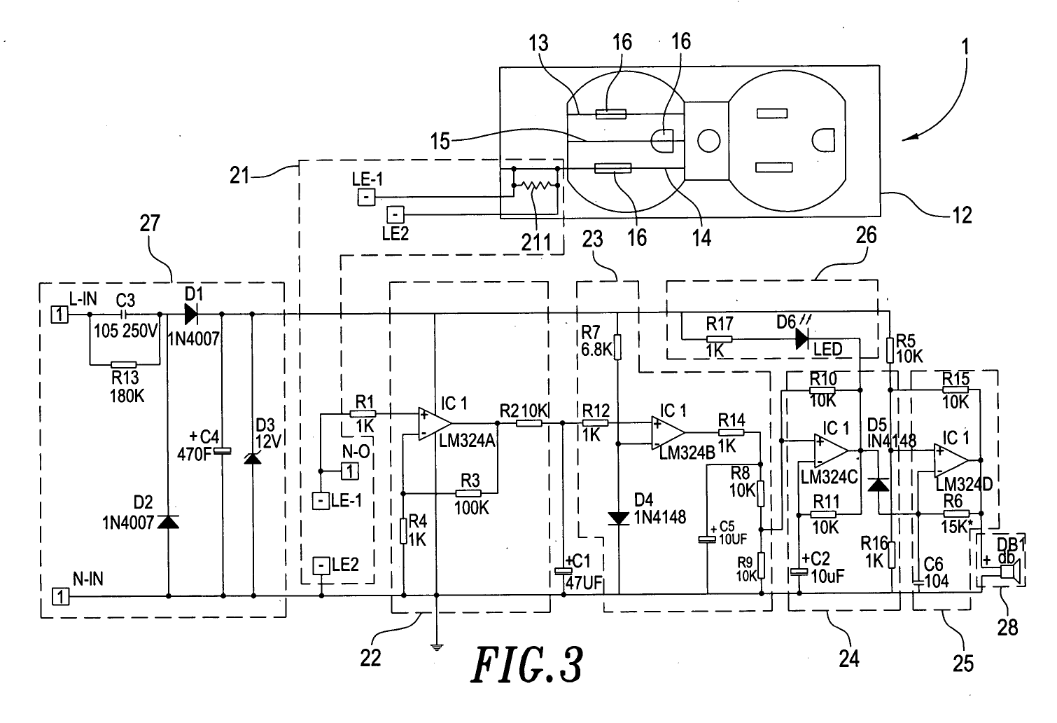

The socket body 1 may be a socket body of an extension cord 11 (as shown in FIG. 2) or a socket body 12 fixedly fitted in a wall (as shown in FIG. 3). The socket body 1 has a positive wire 13, a neutral wire 14 and a negative wire 15, and each of these wires 13, 14 and 15 is connected to a slot 16 in the socket body 1.

The sampling unit 21 may be a resistor 211. The resistor 211 is connected in parallel with the neutral wire 14 or the positive wire 13 so as to obtain the voltage drop signals across the resistor 211.

The amplification unit 22 is connected with the sampling unit 21. The amplification unit 22 may receive and amplify the voltage drop signals.

The comparison unit 23 is connected with the amplification unit 22. The comparison unit 23 may receive the amplified voltage drop signals and compare them with a predetermined voltage value. The unit 23 may send the results of such comparisons to the pulse generating unit 24.

The pulse generating unit 24 is connected with the comparison unit 23 so as to receive the results. If an amplified voltage drop signal is greater than the predetermined voltage value, the pulse generating unit 24 will generate a pulse signal and send it to a driving unit 25 and an LED 26 so that the LED 26 will flash; in the mean time, the driving unit 25 will activate the buzzer 28 to send out a warning sound. The LED 26 and the buzzer 28 may be activated simultaneously or be operated independently.

The DC supply unit 27 may receive AC from the socket body 1 and convert the AC to DC by rectifying, filtering out and stabilizing the AC. The DC may then be fed to the units of the warning device 2.

Whence, when the warning device 2 detects an overload of the socket body 1, a warning sound or flashing light may be sent out to tell a user to unplug one or more electric plugs from the socket body 1 so as to ensure safety.

In contrast to the prior art protective devices, the overload warning device of the present invention has the following two advantages:

1. When there is an overload, the overload warning device of the present invention, which may be disposed inside or outside the sockets, can detect it and sends out a warning sound and/or warning light so as to alert the user and ensure safety.

2. The overload warning device of the present invention may be used for the sockets of an extension cord, sockets fixedly fitted in a wall or other form of sockets.

Although a preferred embodiment of the present invention have been described in detail hereinabove, it should be understood that the preferred embodiment is to be regarded in an illustrative manner rather than a restrictive manner, and many variations and modifications of the basic inventive concepts herein taught still fall within the scope of the present invention.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An overload warning device for electric sockets, comprising:
a socket body, having a positive wire, a neutral wire and a negative wire and each thereof being connected to a slot in a socket so that AC is supplied to appliances; and
a warning device, connected with the positive wire and the neutral wire of the socket body so as to detect a output voltage and to send out a warning sound and/or warning light if the output voltage is greater than a predetermined voltage value.

2. The overload warning device as in claim 1, wherein the warning device is disposed inside or outside the socket body.

3. An overload warning device for electric sockets, comprising:
a socket body, having a positive wire, a neutral wire and a negative wire and each thereof being connected to a slot in a socket so that AC is supplied to appliances; and
a warning device, comprising:
a sampling unit, connected in parallel with the positive wire or the neutral wire so as to obtain voltage drop signals across a sampling unit;
an amplification unit, connected with the sampling unit and to receive and amplify the voltage drop signals;
a comparison unit, connected with the amplification unit and to receive the amplified voltage drop signals, compare with a predetermined voltage value and send results of comparisons to a pulse generating unit; and
a pulse generating unit, connected with the comparison unit so as to receive the results and to generate a pulse signal and send to a driving unit and an LED so that the LED send out flashing light and a buzzer is activated to send out a warning sound if a voltage drop signal is greater than the predetermined voltage value.

4. The overload warning device as in claim 3, wherein the warning device further comprises a DC supply unit, which receives AC from the socket body and convert the AC to DC by rectifying, filtering out and stabilizing the AC so that the DC is then fed to the units of the warning device.

5. The overload warning device as in claim 3, wherein the sampling unit is a resistor

6. The overload warning device as in claim 3, wherein the warning device is disposed inside or outside the socket body.
